(19) United States
(12) Patent Application Publication
(10) Pub. No.: US 2026/0204253 A1
(43) Pub. Date: Jul. 16, 2026

(54) IDENTIFYING MISMATCHED TEXT AND AUDIO FILE BASED ON MACHINE GENERATED TRANSCRIPT

(71) Applicant: Honeywell International Inc., Charlotte, NC (US)

(72) Inventor: Gobinathan Baladhandapani, Madurai (IN)

(73) Assignee: Honeywell International Inc., Charlotte, NC (US)

(21) Appl. No.: 19/062,437

(22) Filed: Feb. 25, 2025

(30) Foreign Application Priority Data
Jan. 13, 2025 (IN) 202511002889

(51) Int. Cl. G10L 15/01; G10L 15/06; G10L 15/26

(52) U.S. Cl. CPC G10L 15/01; G10L 15/063; G10L 15/26

(57) ABSTRACT

A system comprises: memory(s) and processor(s) configured to: record, onboard aircraft, spoken audio communication between air traffic control and pilot onboard aircraft; tag source of spoken audio communication as being air traffic control or pilot onboard aircraft; split spoken audio communication into corresponding separate audio files for source of instruction and action, object type, and/or object identification; remove any corresponding separate audio files for any non-standard words from spoken audio communication which are not included in list of standard vocabulary for communication between air traffic control and pilots; monitor, onboard aircraft, clearances to track when clearances are executed; extract corresponding text for action, object type, and/or object identification from text regarding clearances that are executed; and tag corresponding text with corresponding separate audio file for action, object type, and/or object identification.

### CROSS-REFERENCE TO RELATED APPLICATIONS

This application claims the benefit of Indian Provisional Patent Application Serial No. 202511002889, filed on Jan. 13, 2025 and entitled “IDENTIFYING MISMATCHED TEXT AND AUDIO FILE BASED ON MACHINE GENERATED TRANSCRIPT”, which is hereby incorporated herein by reference in its entirety.

### BACKGROUND

In examples, voice communication between pilots and air traffic control (ATC) includes the exchange of verbal messages between pilots and ATC during flight operations.

### SUMMARY

A system comprises: at least one processor; at least one memory communicatively coupled to the at least one processor; and wherein the at least one processor is configured to: record, onboard an aircraft, spoken audio communication between air traffic control and a pilot onboard the aircraft; tag a source of the spoken audio communication as being at least one of the air traffic control or the pilot onboard the aircraft; split the spoken audio communication into corresponding separate audio files for at least the source of an instruction and at least one of an action, an object type, or an object identification; remove any corresponding separate audio files for any non-standard words from the spoken audio communication which are not included in a list of standard vocabulary for communication between the air traffic control and pilots; monitor, onboard the aircraft, clearances to track when the clearances are executed; extract corresponding text for the at least one of the action, the object type, or the object identification from text regarding the clearances that are executed; and tag the corresponding text with a corresponding separate audio file for the at least one of the action, the object type, or the object identification.

A method comprises: recording, onboard an aircraft, spoken audio communication between air traffic control and a pilot onboard the aircraft; tagging a source of the spoken audio communication as being at least one of the air traffic control or the pilot onboard the aircraft; splitting the spoken audio communication into corresponding separate audio files for at least the source of an instruction and at least one of an action, an object type, or an object identification; removing any corresponding separate audio files for any non-standard words from the spoken audio communication which are not included in a list of standard vocabulary for communication between the air traffic control and pilots; monitoring, onboard the aircraft, clearances to track when the clearances are executed; extracting corresponding text for the at least one of the action, the object type, or the object identification from text regarding the clearances that are executed; and tagging the corresponding text with a corresponding separate audio file for the at least one of the action, the object type, or the object identification.

A non-transitory computer-readable medium comprises a set of instructions that, when executed by at least one processor, cause the at least one processor to: record, onboard an aircraft, spoken audio communication between air traffic control and a pilot onboard the aircraft; tag a source of the spoken audio communication as being at least one of the air traffic control or the pilot onboard the aircraft; split the spoken audio communication into corresponding separate audio files for at least the source of an instruction and at least one of an action, an object type, or an object identification; remove any corresponding separate audio files for any non-standard words from the spoken audio communication which are not included in a list of standard vocabulary for communication between the air traffic control and pilots; monitor, onboard the aircraft, clearances to track when the clearances are executed; extract corresponding text for the at least one of the action, the object type, or the object identification from text regarding the clearances that are executed; and tag the corresponding text with a corresponding separate audio file for the at least one of the action, the object type, or the object identification.

### BRIEF DESCRIPTION OF DRAWINGS

Understanding that the drawings depict only exemplary embodiments and are not therefore to be considered limiting in scope, the exemplary embodiments will be described with additional specificity and detail through the use of the accompanying drawings, in which:

FIG. 1 is a block diagram of a system.

FIG. 2 is a block diagram illustrating example computing system(s).

FIG. 3 is an example method for identifying mismatched text and audio file based on machine generated transcript.

In accordance with common practice, the various described features are not drawn to scale but are drawn to emphasize specific features relevant to the exemplary embodiments.

### DETAILED DESCRIPTION

In the following detailed description, reference is made to the accompanying drawings that form a part hereof, and in which is shown by way of illustration specific illustrative embodiments. However, it is to be understood that other embodiments may be utilized and that logical, mechanical, and electrical changes may be made. Furthermore, the method presented in the drawing figures and the specification is not to be construed as limiting the order in which the individual steps may be performed. The following detailed description is, therefore, not to be taken in a limiting sense.

In examples, voice communication between pilots and air traffic control (ATC) includes the exchange of verbal messages between pilots and ATC during flight operations. In examples, this voice communication between pilots and ATC is an important component of aviation safety and efficiency that enables coordination, information sharing, and conflict resolution among users of an airspace. In examples, voice communication between pilots and ATC poses challenges for natural language processing (NLP) research and application because of its domain-specificity, variability, and complexity as well as based on the varying accents of the various speakers. In examples, the speech engine is tuned based on various accents (such as USA English accent, UK English accent, Chinese English accent, other language accents, etc.). Various words used in voice communication between pilots and ATC may be pronounced in different ways (such as the word “AFRIC”). In examples, a speech engine and/or machine learning model can be improved to better detect the various ways a particular word (such as “AFRIC”) is pronounced by training the machine learning model with the various possible ways so the machine learning model can produce the most accurate output.

While the voice communications between pilots and ATC could be manually decoded and compared to output(s) of transcripts and/or applications, this is complicated and time consuming. In examples, if a word (such as “AFRIC”) is pronounced, but the transcripts and applications produce different output(s), then the how the word (such as “AFRIC”) was pronounced should be used to retrain (or tune) the machine learning model so that the machine learning model will be able to better recognize the word (such as “AFRIC”) even when it is pronounced in a different way. In examples where this is done manually, a person has to manually decode all the conversations and see where things were not decoded correctly and then manually tune the voice engine. In examples where this is implemented manually by humans, this job is tedious, error prone, and time consuming, particularly as some recordings of communication between pilot(s) and ATC for a flight may be over 10 hours in length. In examples, some words are not currently trained in the machine learning model well, but they can be identified and their training improved. In examples, the words that are not currently trained or not trained in well in the machine learning model can be identified based on the surrounding words that are well trained. In examples, the surrounding words can be used to identify a word that is not matched, but is part of the clearance. In examples, when there is a mismatch (that is close to a match), the fields related to the mismatch that is close to the match can be used to retrain or improve training on the machine learning model.

In examples, a corpus is a collection of written text or spoken audio that can be organized into datasets and used for analysis and/or research. In examples, the corpus is used as training data to improve machine learning models so that the machine learning model will be able to better generate the correct text in the future. In examples, the corpus is generated in real-time. In examples, a corpus is collected using voice applications in a cockpit of an aircraft. In examples, voice applications may be executed using a mobile device (such as a tablet, laptop, or smartphone) within the cockpit of the aircraft. In examples, the mobile device receives data from the voice applications in the cockpit of the aircraft. In examples, there is an interface to the onboard portion for the mobile device. In examples, the mobile device (such as a tablet, laptop, or smartphone) directly interfaces with the text extraction system/module 108 and/or the clearance monitoring system/module 106.

In examples, use of voice applications for pilot(s) helps to reduce the pilot workload and ease operation for pilots in the cockpit. In examples, the availability of a corpus of voice communication between pilots and ATC may be affected by various factors. In examples, there are technical and logistical difficulties in accessing and collecting voice communication data from multiple sources, such as radio frequencies, cockpit voice recorders, and radar data. In examples, there is substantial cost and effort involved in transcribing, annotating, and validating the voice communication data, which requires domain expertise and quality control. In examples, there are privacy and security concerns of data providers and users, who may have different interests and expectations regarding the use and reuse of the data. In examples, there is a lack of standardization and interoperability of the data formats, metadata, and annotations, which hinders the comparability and usability of the data across different systems and platforms. In examples, many of the pilots are not native English speakers. In examples, there is a substantial amount of cockpit and/or ATC environment noise included along with the voice data.

In examples, generally available speech engines work well for normal language, but are not specific to the domain of communication between pilots and ATC. In the domain of communication between pilots and ATC (and aerospace generally), domain centric terms are used which are not used in normal speech applications. In examples, the domain centric terms may include waypoint names, values, various call signs, and/or various terminologies used in communication between pilots and ATC, which are not available under other speech engines. In examples, the vocabulary used in the voice communication between the pilots and ATC cannot be arrived at from standard language vocabulary due to variety of textual abbreviated and non-standard words. In examples, while the standard set of words are easier to train, the words which are in the databases like navigation, airport surface map, and/or other databases are more difficult to train. In examples of a successful cockpit voice engine, both common words and database words have to be decoded with higher accuracy. In examples, these various challenges create barriers for the creation and sharing of a corpus of voice communication between pilots and ATC. In examples, the supported grammar is limited to improve accuracy to as close to 100% accuracy as possible.

In examples, training data can be collected from a cockpit environment and then used offline to train the machine learning model (such as an acoustic model) to improve accuracy. In examples, training data can be collected from a cockpit environment and then used in real-time to train the machine learning model (such as an acoustic model) to improve accuracy. In examples of a traditional voice engine, standard English words are used, but the way the words are pronounced and used in context of voice communication between pilots and ATC is different. In examples, training the words with standard pronunciation does not help to achieve a higher rate of accuracy in the domain of voice communication between pilots and ATC.

In examples, a system can take input from a voice transcription system/module and a clearance monitoring system/module and make determinations regarding which words were incorrectly transcribed and then provide the spoken word and the text word it should be back to a machine learning model for retraining. In examples, the retraining could happen after an airplane lands and the data regarding the voice and text for the various words (also referred to as the corpus) is retrieved from onboard systems and used to retrain the machine learning model to improve the machine learning model's ability to identify various ATC specific words that are pronounced differently in different accents. In examples, the voice and text data regarding the various words (also referred to as the corpus) is provided to an external system to retrain/tune the machine learning model offline and then the updated machine learning model is provided back to the aircraft avionics for improved recognition. In examples, the machine learning model could be retrained in real-time adaptively using a machine learning algorithm running on a mobile device (such as a tablet, laptop, or smartphone) or aircraft avionics.

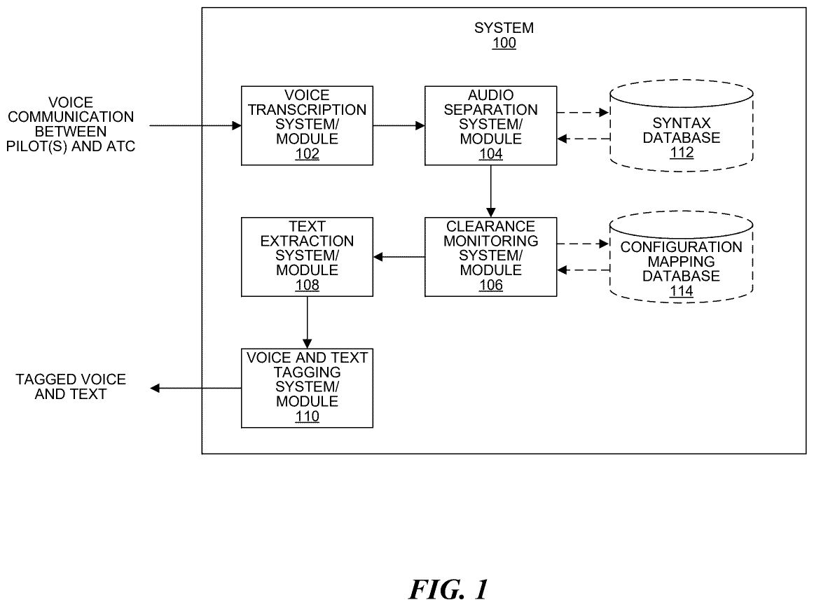

FIG. 1 is a block diagram of a system 100. In examples, any of the components of system 100 can be implemented using any of the physical components and/or circuitry of example computing system(s) 200 described below. In examples, the system 100 includes a voice transcription system/module 102, an audio separation system/module 104, a clearance monitoring system/module 106, a text extraction system/module 108, a voice and text tagging system/module 110, an optional syntax database 112, and an optional configuration mapping database 114.

In examples, data for training the machine learning model (such as an acoustic model) of the speech transcription application is collected by listening to voice data between pilots of other aircraft and ATC. In examples, text of the spoken audio of the voice communication between the pilots and ATC is used as the aviation convention by extracting the corresponding text from the cockpit systems and the databases used in cockpit systems. In examples, the accuracy of detection of words which are pronounced in a different way in aviation than standard English. In examples, this includes runway, taxiway, and/or waypoint identifiers for which the machine learning model (such as an acoustic model) cannot be trained due to lack of training data, altitude, and/or heading and/or other numeric values which are pronounced and used differently. In examples, collecting training data from cockpit systems for a transcription system for voice communication between pilots and ATC improves the building of domain-specific language models for us in language processing applications. In examples, collecting training data from cockpit systems for a transcription system for voice communication between pilots and ATC improves the creation of a language model from a task-independent corpus and allows for a speaker-independent speech recognition system with reduced latency.

In examples, the voice transcription system/module 102 is configured to receive voice communication between pilot(s) and ATC (such as from a pilot headset/speaker through an audio panel onboard an aircraft). In examples, this voice communication between pilot(s) and ATC is received as voice data between pilot(s) of aircraft and the ATC from cockpit systems. In examples, the voice transcription system/module 102 is configured to transcribe the voice data into written text. In examples, the audio separation system/module 104 is configured to separate the voice data into audio clips of various words. In examples, only audio clips of the relevant words are used instead of the complete clearance. In examples, only the audio files/snippets/samples of the audio that match the specific word are included and can be used to retrain (or tune) the machine learning model used by the voice transcription system/module 102. In examples, the audio separation system/module 104 receives information from the optional syntax database 112 regarding syntax to make determinations to identify which audio files/snippets/samples are relevant. In examples, the audio separation system/module 104 communicates updated information regarding syntax to the optional syntax database 112.

In examples, the voice transcription system/module 102 is configured to transcribe text from voice communication between pilots and the ATC from various aircraft. In examples, the clearance monitoring system/module 104 is configured to monitor execution by the pilot(s) of instructions given to the pilot(s) by the ATC in the voice communications. In examples, the clearance monitoring system/module 106 begins monitoring execution of a clearance once the clearance is received. In examples, an instruction may be given to the pilot(s) (such as “climb to AFRIC and maintain level”). In examples, the instruction requires some associated cockpit action be performed by the pilot(s). In examples, the system can improve for accents of the various speakers by mapping the correlation between a particular accent and a particular clearance. In examples, whatever the pilot enters into the cockpit is used to map the recorded audio clip in the accent to a particular clearance. In examples, if the clearance is “climb to AFRIC” in the audio claim in the particular accent and the pilot is going to the AFRIC waypoint and level off at the AFRIC waypoint, the system can identify the term “AFRIC” as the keyword and determine that “AFRIC” was the clearance that was given because the pilot executed the “AFRIC” clearance, even if the system does not initially understand “AFRIC” in the particular accent. In examples, the clearance monitoring system/module 104 is part of the aircraft avionics. In examples, the clearance monitoring system/module 104 includes an interface to communication data. In examples, the clearance monitoring system/module 104 is implemented with a mobile device (such as a tablet, laptop, or smartphone).

In examples, because the system 100 identifies from the clearance monitoring system/module 106 once the execution has occurred, the system 100 can identify that what was being said in the clip (part of the speech) of the previous clearance (even with accents that the voice transcription system/module 102 does not initially understand). In examples, by correlating the language of the clip (part of the speech) of the previous clearance after execution with the clearance, the machine learning model used by the voice transcription system/module 102 is further trained. In examples, a confidence score can be assigned based on what the voice transcription system/module 102 decodes as the clearance. In examples, the word with the highest confidence score is determined to be the word. In examples, when new words (not well trained by the machine learning model) are provided, the audio file/snippet/sample and the text of the new word can be used to retrain the machine learning model. In examples, after the machine learning model is retrained using the audio file/snippet/sample and text of the new word, the machine learning model will be better able to identify the text for the particular audio of the new word. In examples, a configuration in the optional configuration mapping database 114 is configured to map various clearances with sources, triggers, and/or other mapping configuration(s). In examples, the configuration is received at the clearance monitoring system/module 106 from the optional configuration mapping database 114.

In examples, a person (such as a human engineer on the ground) may also decode the audio clip and if the person also decoded the keyword as “AFRIC”, then there is no issue. If the person decoded the keyword in a different way, then the engine may be tuned based on the person decoding the audio clip differently. In examples, a human may be decoding this in real time and if there is a mismatch in the transcripts and the application based on the pilot accent (such as the word “AFRIC” not being decoded properly), then the audio clip can be tagged correctly to improve the system. In examples, the audio clip can be combined with new speech as well (such as on the ground after landing).

In examples, a text extraction system/module 108 is configured to search for the text for a specific spoken word in a clearance. In examples, the voice and text tagging system/module 110 is implemented using a mobile device (such as a tablet, laptop, or smartphone). In examples, the voice and text tagging system/module 110 is configured to tag spoken word(s) with text which is then used for training a voice engine. In examples, the voice and text tagging system/module 110 extracts the corresponding text. In examples, the voice and text tagging system/module 110 tags the audio clip with the text of the clearance. In examples, the voice and text tagging system/module 110 generate at least one file with the audio clip and the corresponding text of the clearance. In examples, the voice and text tagging system/module 110 generates tagged voice and text.

In examples, the tagged voice and text is output as part of a corpus of data from the system 100 (such as by the voice and text tagging system/module 110). In examples, the corpus of tagged voice and text is provided to a database to be used to retrain (or tune) the machine learning model used by the voice transcription system/module 102 to improve accuracy using more corpus including the specific words that were incorrectly identified by the voice transcription system based on various accents or other reasons. In examples, the corpus file can be provided to the machine learning model for retraining at the end of the flight. In examples, the retrained machine learning model can be redeployed to the aircraft avionics in between flights. In examples, the corpus file can be provided to the machine learning model as it is received mid-flight. In examples, the retrained machine learning model can be redeployed to the aircraft avionics mid-flight. In examples, the retrained machine learning model will help the machine learning model more intelligently match language to the text for future clearances.

In examples, a database system includes action(s), object(s), and/or parameter(s) pair(s) and/grouping(s), such as: (1) “Climb, MCP_Altitude” or (2) “Speed, MCP_Heading”. In examples, the system 100 (such as by the voice transcription system/module 102) is configured to record each sentence spoken by ATC (and/or pilot(s)). In examples, the system 100 (such as by the audio separation system/module 104) is configured to split each sentence such that each separated sentence contains various elements, such as: (1) Source(s), (2) Action(s), (3) Object(s), (4) Object ID(s), (5) Info portion(s) of the sentence. In examples, if the instruction contains multiple instructions, each instruction is split.

In an particular example, a sentence “FLAGSHIP FORTY-ONE NINETY TWO ON KILO CROSS RUNWAY TWO TWO RIGHT IN CONTACT GROUND POINT NINER” may be split into a few separated elements. First, “ATC, FLAGSHIP FORTY ONE NINETY TWO” includes the source “ATC” and the call sign of the aircraft “FLAGSHIP FORTY ONE NINETY TWO”. Second, “ATC, TAXIWAY KILO” includes the source “ATC”, the Object “TAXIWAY” and the Object ID “KILO” corresponding to the Object “TAXIWAY” where an aircraft is being requested to use taxiway KILO. Third, “ATC, RUNWAY TWO TWO RIGHT” includes the source “ATC”, the Object “RUNWAY” and the Object ID “TWO TWO RIGHT” corresponding to the Object “RUNWAY” where an aircraft is being requested to use runway TWO TWO RIGHT. Fourth, “ATC, CONTACT GROUND POINT NINER” includes the source “ATC”, the action “CONTACT”, the Object “GROUND POINT”, and the Object ID “NINER” where an aircraft is being requested to contact a ground point “NINER”.

In examples, the system 100 (such as by the voice transcription system/module 102) is configured to tag the source of each instruction. In examples, the source of each instruction may be ATC, the pilot of the current aircraft (also referred to as the ownship pilot), or pilots of other aircraft. In examples, the system 100 (such as by the audio separation system/module 104) is configured to remove any non-standard words from the sentence with the help of syntactic processing. In examples, the non-standard words are removed by the system 100 (such as by the audio separation system/module 104) using an intelligent system or a rule base system. In examples, the non-standard words are removed using a rule based system with a list of standard words and if a particular word is not included in the list of standard words, then the word is determined to be non-standard and can be removed. In examples, the non-standard words are removed using an intelligent system that may remove a word such as “minutes” because it is a non-standard word and the system 100 does not need to focus on it.

In examples, non-standard words are words which are not in the communication vocabulary for the voice communication between the pilot(s) and ATC. In examples, the system 100 is configured to not retrain (or tune) the machine learning model used by the voice transcription system/module 102 based on the non-standard words. In examples, an audio file/snippet/sample of the target audio is generated by removing non-standard words. In examples, the corresponding text for the audio file/snippet/sample is extracted from existing systems. In examples, the exact text is queried for the objects identified in the audio file/snippet/sample which are available as parameters or database values in the cockpit systems. In examples, this is achieved as described below.

In examples, the clearance monitoring system/module 106 monitors the clearances and tracks when the clearances are executed (completed). In examples, pilots do not automatically and immediately do the things in the clearance. In examples, the pilot may do things that are not relevant to the clearance first or while waiting for the aircraft to reach a location required by the clearance (such as AFRIC). In examples, for each clearance, a location profile is generated which includes all the geographic locations the aircraft would be at on the scale of time. In examples, this profile is input to the cockpit systems (FMS/INAV) to obtain various named elements that exit throughout the profile path, such as waypoint, runway, taxiway, etc. In examples, the element and its value are extracted from the profile.

In examples, the clearance monitoring system/module 106 is configured to attempt to identify the clearance in audio clips even with accents of the spoken words. In examples, the voice transcription system/module 102 may not transcribe correctly based on accent and maturity of the machine learning model used by the voice transcription system/module 102 and may produce incorrect output. In examples,

In examples, a configuration mapping system includes mapping between various elements, such as shown in example Tables 1-3 below.

TABLE 1

| | |
|---|---|
| Instruction | CONTACT [icaofacilityname] |
| | [icaofacilityfunction] ON [frequency] |
| Decodable objects | CONTACT, ON |
| from clearance | |
| Event data source | RMP—Radio Management Panel |
| Post event data source | NAV DB |
| Perform semantic check | NO |
| and determine | |
| conditionality, Is | |
| conditional | |
| Conditional Event | N/A |
| Conditional Data Source | N/A |
| Conditional Element | N/A |
| Event Raised when | Frequency set on RMP |
| Post event Rule | Query [icaofacilityname] with frequency |
| | from = [post event data source] with event data |
| | source value |
| Post event action - once | Query [icaofacilityname] with frequency from |
| frequency is set to 116.2 | RMP with 116.2 |
| in RMP | |

TABLE 2

| | |
|---|---|
| Instruction | AT [position] MONITOR [icaofacilityname] |
| | [icaofacilityfunction] ON [frequency] |
| Decodable objects | AT, MONITOR, ON |
| from clearance | |
| Event data source | RMP |
| Post event data source | NAV DB |
| Perform semantic check | YES |
| and determine | |
| conditionality, Is | |
| conditional | |
| Conditional Event | AT [position] |
| Conditional Data Source | FMS |
| Conditional Element | Near by waypoint, navaid identifier |
| Event Raised when | Frequency set on RMP |
| Post event Rule | Query [icaofacilityname] with frequency |
| | from = [post event data source] with event data |
| | source value and query conditional element |
| | from Conditional data source |
| Eg: Post event action - | Query [icaofacilityname] with frequency from |
| once frequency is set to | RMP with 116.2, Query nearby waypoint |
| 116.2 in RMP | AFRIC from FMS. |

TABLE 3

| | |
|---|---|
| Instruction | AT [time] DESCEND TO AND MAINTAIN |
| | [altitude] |
| Decodable objects from | AT, DESCEND, TO, AND MAINTAIN |
| clearance | |
| Event data source | MCP Altitude |
| Post event data source | Clock |
| Perform semantic check | YES |
| and determine | |
| conditionality, Is | |
| conditional | |
| Conditional Event | AT [time] |
| Conditional Data Source | Clock |
| Conditional Element | Time when changing altitude |
| Event Raised when | Frequency set on RMP |
| Post event Rule | Query [time] from clock with frequency from = |
| | [post event data source] with event data source |
| | value |
| Eg: Post event action - | Query [time] from clock with frequency from |
| once Alt is set to 10000 | MCP set to 10000 |
| in MCP | |

In examples, the text extraction system is used with help of a configuration mapping system, to query the required text from the data extracted from the location profile generated out of the clearance monitoring system.

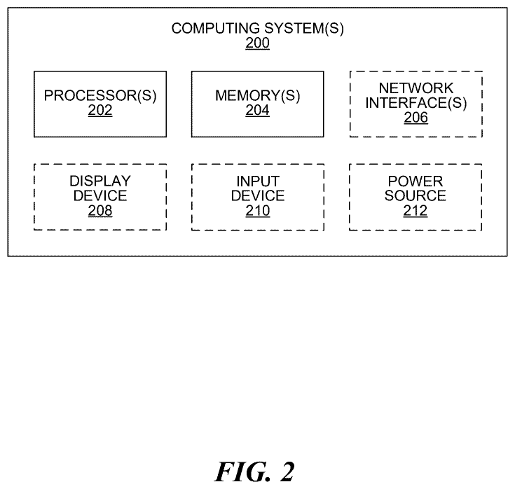

FIG. 2 is a block diagram illustrating example computing system(s) 200. The computing system(s) 200 includes at least one processor 202, at least one memory 204, optional at least one network interface 206, optional at least one display device 208, optional at least one input device 210, and optional at least one power source 212.

In examples, the at least one memory 204 can be any device, mechanism, or populated data structure used for storing information. In examples, the at least one memory 204 can be or include any type of volatile memory, nonvolatile memory, and/or dynamic memory. In examples, the at least one memory 204 can be random access memory, memory storage devices, optical memory devices, magnetic media, floppy disks, magnetic tapes, hard drives, erasable programmable read-only memories (EPROMs), electrically erasable programmable read-only memories (EEPROMs), optical media (such as compact discs, DVDs, Blu-ray Discs) and/or the like.

The at least one processor 202 can be any known processor, such as a general purpose processor (GPP) or special purpose (such as a field-programmable gate array (FPGA), application-specific integrated circuit (ASIC) or other integrated circuit or circuitry), any programmable logic device, or any circuitry. In examples, any of the functionality disclosed herein may be implemented by the at least one processor 202 and the at least one memory 204.

In accordance with some embodiments, the at least one memory 204 may include one or more disk drives, flash drives, one or more databases, one or more tables, one or more files, local cache memories, processor cache memories, relational databases, flat databases, and/or the like. In addition, those of ordinary skill in the art will appreciate many additional devices and techniques for storing information, which can be used as the at least one memory 204. The at least one memory 204 may be used to store instructions for running one or more applications or modules on the at least one processor 202. In examples, the at least one memory 204 could be used in one or more examples to house all or some of the instructions needed to execute the functionality discussed herein.

In examples, the optional at least one network interface 206 includes or is coupled to at least one optional antenna for communication with a network. In examples, the optional at least one network interface 206 includes at least one of an Ethernet interface, a cellular radio access technology (RAT) radio, a Wi-Fi radio, a Bluetooth radio, or a near field communication (NFC) radio. In examples, the optional at least one network interface 206 includes a cellular radio access technology radio configured to establish a cellular data connection (mobile Internet) of sufficient speeds with a remote server using a local area network (LAN) or a wide area network (WAN). In examples, the cellular radio access technology includes at least one of Personal Communication Services (PCS), Specialized Mobile Radio (SMR) services, Enhanced Special Mobile Radio (ESMR) services, Advanced Wireless Services (AWS), Code Division Multiple Access (CDMA), Global System for Mobile Communications (GSM) services, Wideband Code Division Multiple Access (W-CDMA), Universal Mobile Telecommunications System (UMTS), Worldwide Interoperability for Microwave Access (WiMAX), 3rd Generation Partnership Projects (3GPP) Long Term Evolution (LTE), High Speed Packet Access (HSPA), third generation (3G) fourth generation (4G), fifth generation (5G), etc. or other appropriate communication services or a combination thereof. In examples, the optional at least one network interface 206 includes a Wi-Fi (IEEE 802.11) radio configured to communicate with a wireless local area network that communicates with the remote server, rather than a wide area network. In examples, the optional at least one network interface 206 includes a near field radio communication device that is limited to close proximity communication, such as a passive near field communication (NFC) tag, an active near field communication (NFC) tag, a passive radio frequency identification (RFID) tag, an active radio frequency identification (RFID) tag, a proximity card, or other personal area network device.

In examples, the optional at least one display device 208 includes at least one of a light emitting diode (LED), a liquid crystal display (LCD), a light emitting diode (LED) display, an organic light emitting diode (OLED) display, an e-ink display, a field emission display (FED), a surface-conduction electron-emitter display (SED), or a plasma display. In examples, the optional at least one input device 210 includes at least one of a touchscreen (including capacitive and resistive touchscreens), a touchpad, a capacitive button, a mechanical button, a switch, a dial, a keyboard, a mouse, a camera, a biometric sensor/scanner, a microphone, etc. In examples, the optional at least one display device 208 is combined with the optional at least one input device 210 into a human machine interface (HMI) for user interaction with the computing system(s) 200. In examples, optional at least one power source 212 is used to provide power to the various components of the computing system(s) 200.

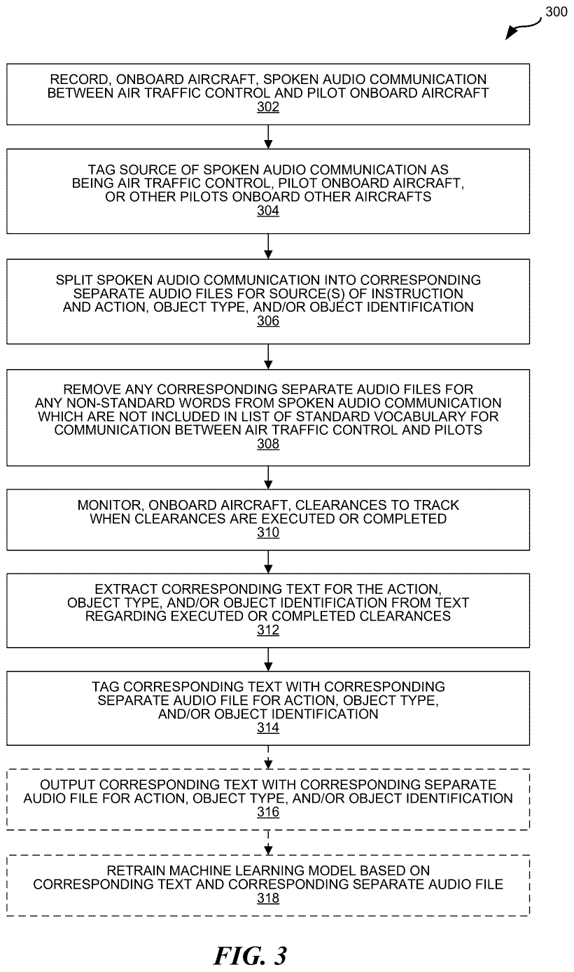

FIG. 3 is an example method 300 for identifying mismatched text and audio file based on machine generated transcript. In examples, the example method 300 is executed using any of system 100 or computing system(s) 200 described above. In examples, method 300 begins at block 302 with recording, onboard an aircraft, spoken audio communication between air traffic control and a pilot onboard the aircraft. In examples, the recording occurs using avionics onboard the aircraft, though it can also be performed using other devices. In examples, method 300 proceeds to block 304 with tagging the source of the spoken audio communication as being at least one of the air traffic control or the pilot onboard the aircraft. In examples, the tagging occurs using avionics onboard the aircraft, though it can also be performed using other devices. In examples, method 300 proceeds to block 306 with splitting the spoken audio communication into corresponding separate audio files for at least a source of an instruction and at least one of an action, an object type, or an object identification. In examples, the splitting occurs using avionics onboard the aircraft, though it can also be performed using other devices.

In examples, method 300 proceeds to block 308 with removing any corresponding separate audio files for any non-standard words from the spoken audio communication which are not included in a list of standard vocabulary for communication between the air traffic control and pilots. In examples, the removing occurs using avionics onboard the aircraft, though it can also be performed using other devices. In examples, method 300 proceeds to block 310 with monitoring, onboard the aircraft, clearances to track when the clearances are executed. In examples, the monitoring occurs using avionics onboard the aircraft, though it can also be performed using other devices. In examples, method 300 proceeds to block 312 with extracting corresponding text for the at least one of the action, the object type, or the object identification from text regarding the clearances that are executed. In examples, the extracting occurs using avionics onboard the aircraft, though it can also be performed using other devices.

In examples, method 300 proceeds to block 314 with tagging the corresponding text with a corresponding separate audio file for the at least one of the action, the object type, or the object identification. In examples, the tagging occurs using a mobile device onboard the aircraft, though it can also be performed using other devices. In examples, method 300 proceeds to optional block 316 with outputting the corresponding text and the corresponding separate audio file. In examples, the outputting occurs using a mobile device onboard the aircraft, though it can also be performed using other devices. In examples, the corresponding text and the corresponding separate audio file are a corpus of data. In examples, method 300 proceeds to optional block 318 with retraining a machine learning model based on the corresponding text and the corresponding separate audio file. In examples, retraining the machine learning model based on the corresponding text and the corresponding separate audio file improves an ability of the machine learning model to identify a word corresponding to the corresponding text and the corresponding separate audio file. In examples, method 300 includes combining the corresponding text and the corresponding separate audio file with other corresponding text and corresponding audio files to generate a corpus of data used to retrain the machine learning model.

The methods and techniques described herein may be implemented in digital electronic circuitry, or with a programmable processor (for example, a special-purpose processor or a general-purpose processor such as a computer) firmware, software, or in various combinations of each. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor communicatively coupled to receive data and instructions from, and to transmit data and instruction to, a data storage system, at least one input device, and at least one output device. Generally, a processor will receive instructions and data from a read-only memory and/or a random-access memory. Storage devices suitable for tangibly embodying computer program instructions and data include all forms of non-volatile memory and storage media, including by way of example random access memory, memory storage devices, optical memory devices, magnetic media, floppy disks, magnetic tapes, hard drives, erasable programmable read-only memories (EPROMs), electrically erasable programmable read-only memories (EEPROMs), optical media (such as compact discs, DVDs, Blu-ray Discs), magneto-optical disks, and/or the like. Any of the foregoing may be supplemented by, or incorporated in, any known processor, such as a general purpose processor (GPP) or special purpose (such as a field-programmable gate array (FPGA), application-specific integrated circuit (ASIC) or other integrated circuit or circuitry), or any programmable logic device.

While detailed descriptions of one or more embodiments of the disclosure have been given above, various alternatives, modifications, and equivalents will be apparent to those skilled in the art without varying from the spirit of the disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof. Therefore, the above description should not be taken as limiting.

### Examples

Example 1 includes a system, comprising: at least one processor; at least one memory communicatively coupled to the at least one processor; and wherein the at least one processor is configured to: record, onboard an aircraft, spoken audio communication between air traffic control and a pilot onboard the aircraft; tag a source of the spoken audio communication as being at least one of the air traffic control or the pilot onboard the aircraft; split the spoken audio communication into corresponding separate audio files for at least the source of an instruction and at least one of an action, an object type, or an object identification; remove any corresponding separate audio files for any non-standard words from the spoken audio communication which are not included in a list of standard vocabulary for communication between the air traffic control and pilots; monitor, onboard the aircraft, clearances to track when the clearances are executed; extract corresponding text for the at least one of the action, the object type, or the object identification from text regarding the clearances that are executed; and tag the corresponding text with a corresponding separate audio file for the at least one of the action, the object type, or the object identification.

Example 2 includes the system of Example 1, wherein the at least one processor comprises: at least a first processor integrated into avionics systems integrated into the aircraft, the at least the first processor configured to: record, onboard the aircraft, the spoken audio communication between the air traffic control and the pilot onboard the aircraft; tag the source of the spoken audio communication as being the at least one of the air traffic control or the pilot onboard the aircraft; split the spoken audio communication into the corresponding separate audio files for at least the source of the instruction and the at least one of the action, the object type, or the object identification; remove any corresponding separate audio files for any non-standard words from the spoken audio communication which are not included in the list of the standard vocabulary for the communication between the air traffic control and pilots; monitor, onboard the aircraft, the clearances to track when the clearances are executed; extract the corresponding text for the at least one of the action, the object type, or the object identification from the text regarding the clearances that are executed; and at least a second processor integrated into a mobile device onboard the aircraft, the at least the second processor configured to: tag the corresponding text with the corresponding separate audio file for the at least one of the action, the object type, or the object identification.

Example 3 includes the system of any of Examples 1-2, wherein the mobile device is selected from at least one of a tablet, a laptop, and a smartphone.

Example 4 includes the system of any of Examples 1-3, wherein the at least one processor is configured to implement: a voice transcription system configured to: record the spoken audio communication between the air traffic control and the pilot onboard the aircraft; and tag the source of the spoken audio communication as being the at least one of the air traffic control or the pilot onboard the aircraft; an audio separation system configured to: split the spoken audio communication into the corresponding separate audio files for at least the source of the instruction and the at least one of the action, the object type, or the object identification; and remove any corresponding separate audio files for any non-standard words from the spoken audio communication which are not included in the list of the standard vocabulary for the communication between the air traffic control and the pilots; a clearance monitoring system configured to: monitor the clearances to track when the clearances are executed; a text extraction system configured to: extract the corresponding text for the at least one of the action, the object type, or the object identification from the text regarding the clearances that are executed; and a voice and text tagging system configured to: tag the corresponding text with the corresponding separate audio file for the at least one of the action, the object type, or the object identification.

Example 5 includes the system of any of Examples 1-4, wherein the at least one processor is further configured to: output the corresponding text with the corresponding separate audio file for the at least one of the action, the object type, or the object identification.

Example 6 includes the system of Example 5, wherein the at least one processor is further configured to: retraining a machine learning model based on the corresponding text and the corresponding separate audio file.

Example 7 includes the system of any of Examples 5-6, wherein the at least one processor is further configured to: combine the corresponding text and the corresponding separate audio file with other corresponding text and corresponding audio files to generate a corpus of data; and retrain a machine learning model based on the corpus of data.

Example 8 includes a method comprising: recording, onboard an aircraft, spoken audio communication between air traffic control and a pilot onboard the aircraft; tagging a source of the spoken audio communication as being at least one of the air traffic control or the pilot onboard the aircraft; splitting the spoken audio communication into corresponding separate audio files for at least the source of an instruction and at least one of an action, an object type, or an object identification; removing any corresponding separate audio files for any non-standard words from the spoken audio communication which are not included in a list of standard vocabulary for communication between the air traffic control and pilots; monitoring, onboard the aircraft, clearances to track when the clearances are executed; extracting corresponding text for the at least one of the action, the object type, or the object identification from text regarding the clearances that are executed; and tagging the corresponding text with a corresponding separate audio file for the at least one of the action, the object type, or the object identification.

Example 9 includes the method of Example 8, further comprising: recording, using avionics onboard the aircraft, the spoken audio communication between the air traffic control and the pilot onboard the aircraft; tagging, using the avionics onboard the aircraft, the source of the spoken audio communication as being the at least one of the air traffic control or the pilot onboard the aircraft; splitting, using the avionics onboard the aircraft, the spoken audio communication into the corresponding separate audio files for the at least the source of the instruction and the at least one of the action, the object type, or the object identification; removing, using the avionics onboard the aircraft, any corresponding separate audio files for any non-standard words from the spoken audio communication which are not included in the list of the standard vocabulary for the communication between the air traffic control and the pilots; monitoring, using the avionics onboard the aircraft, the clearances to track when the clearances are executed; extracting, using the avionics onboard the aircraft, the corresponding text for the at least one of the action, the object type, or the object identification from the text regarding the clearances that are executed; and tagging, using a mobile device onboard the aircraft, the corresponding text with the corresponding separate audio file for the at least one of the action, the object type, or the object identification.

Example 10 includes the method of Example 9, wherein the mobile device is selected from at least one of a tablet, a laptop, and a smartphone.

Example 11 includes the method of any of Examples 8-10, further comprising: recording, using a voice transcription system, the spoken audio communication between the air traffic control and the pilot onboard the aircraft; tagging, using a voice and text tagging system, the source of the spoken audio communication as being the at least one of the air traffic control or the pilot onboard the aircraft; splitting, using an audio separation system, the spoken audio communication into the corresponding separate audio files for the at least the source of the instruction and the at least one of the action, the object type, or the object identification; removing, using the audio separation system, any corresponding separate audio files for any non-standard words from the spoken audio communication which are not included in the list of the standard vocabulary for the communication between the air traffic control and the pilots; monitoring, using a clearance monitoring system, the clearances to track when the clearances are executed; extracting, using a text extraction system, the corresponding text for the at least one of the action, the object type, or the object identification from the text regarding the clearances that are executed; and tagging, using the voice and text tagging system, the corresponding text with the corresponding separate audio file for the at least one of the action, the object type, or the object identification.

Example 12 includes the method of any of Examples 8-11, further comprising: outputting the corresponding text with the corresponding separate audio file for the at least one of the action, the object type, or the object identification.

Example 13 includes the method of Example 12, further comprising: retraining a machine learning model based on the corresponding text and the corresponding separate audio file.

Example 14 includes the method of any of Examples 12-13, further comprising: combining the corresponding text and the corresponding separate audio file with other corresponding text and corresponding audio files to generate a corpus of data; and retraining a machine learning model based on the corpus of data.

Example 15 includes a non-transitory computer-readable medium comprises a set of instructions that, when executed by at least one processor, cause the at least one processor to: record, onboard an aircraft, spoken audio communication between air traffic control and a pilot onboard the aircraft; tag a source of the spoken audio communication as being at least one of the air traffic control or the pilot onboard the aircraft; split the spoken audio communication into corresponding separate audio files for at least the source of an instruction and at least one of an action, an object type, or an object identification; remove any corresponding separate audio files for any non-standard words from the spoken audio communication which are not included in a list of standard vocabulary for communication between the air traffic control and pilots; monitor, onboard the aircraft, clearances to track when the clearances are executed; extract corresponding text for the at least one of the action, the object type, or the object identification from text regarding the clearances that are executed; and tag the corresponding text with a corresponding separate audio file for the at least one of the action, the object type, or the object identification.

Example 16 includes the non-transitory computer-readable medium of Example 15, further comprising: wherein the set of instructions comprises a first subset of instructions and a second subset of instructions; wherein the at least one processor comprises: at least a first processor integrated into avionics systems integrated into the aircraft; and at least a second processor integrated into a mobile device onboard the aircraft; wherein the first subset of instructions, when executed by the at least the first processor integrated into the avionics systems integrated into the aircraft, cause the at least the first processor to: record, onboard the aircraft, the spoken audio communication between air traffic control and the pilot onboard the aircraft; tag the source of the spoken audio communication as being the at least one of the air traffic control or the pilot onboard the aircraft; and split the spoken audio communication into the corresponding separate audio files for at least the source of the instruction and the at least one of the action, the object type, or the object identification; remove any corresponding separate audio files for any non-standard words from the spoken audio communication which are not included in the list of the standard vocabulary for the communication between the air traffic control and pilots; monitor, onboard the aircraft, the clearances to track when the clearances are executed; extract the corresponding text for the at least one of the action, the object type, or the object identification from the text regarding the clearances that are executed; and wherein the first subset of instructions, when executed by the at least the second processor integrated into the mobile device onboard the aircraft, cause the at least the second processor to: tag the corresponding text with the corresponding separate audio file for the at least one of the action, the object type, or the object identification.

Example 17 includes the non-transitory computer-readable medium of Example 16, wherein the mobile device is selected from at least one of a tablet, a laptop, and a smartphone.

Example 18 includes the non-transitory computer-readable medium of any of Examples 16-17, wherein the set of instructions further cause the at least one processor to: output the corresponding text with the corresponding separate audio file for the at least one of the action, the object type, or the object identification.

Example 19 includes the non-transitory computer-readable medium of Example 18, wherein the set of instructions further cause the at least one processor to: retrain a machine learning model based on the corresponding text and the corresponding separate audio file.

Example 20 includes the non-transitory computer-readable medium of any of Examples 18-19, wherein the set of instructions further cause the at least one processor to: combine the corresponding text and the corresponding separate audio file with other corresponding text and corresponding audio files to generate a corpus of data; and retrain a machine learning model based on the corpus of data.

What is claimed is:

1. A system, comprising:
at least one processor;
at least one memory communicatively coupled to the at least one processor; and
wherein the at least one processor is configured to:
record, onboard an aircraft, spoken audio communication between air traffic control and a pilot onboard the aircraft;
tag a source of the spoken audio communication as being at least one of the air traffic control or the pilot onboard the aircraft;
split the spoken audio communication into corresponding separate audio files for at least the source of an instruction and at least one of an action, an object type, or an object identification;
remove any corresponding separate audio files for any non-standard words from the spoken audio communication which are not included in a list of standard vocabulary for communication between the air traffic control and pilots;
monitor, onboard the aircraft, clearances to track when the clearances are executed;
extract corresponding text for the at least one of the action, the object type, or the object identification from text regarding the clearances that are executed; and
tag the corresponding text with a corresponding separate audio file for the at least one of the action, the object type, or the object identification.

2. The system of claim 1, wherein the at least one processor comprises:
at least a first processor integrated into avionics systems integrated into the aircraft, the at least the first processor configured to:
record, onboard the aircraft, the spoken audio communication between the air traffic control and the pilot onboard the aircraft;
tag the source of the spoken audio communication as being the at least one of the air traffic control or the pilot onboard the aircraft;
split the spoken audio communication into the corresponding separate audio files for at least the source of the instruction and the at least one of the action, the object type, or the object identification;
remove any corresponding separate audio files for any non-standard words from the spoken audio communication which are not included in the list of the standard vocabulary for the communication between the air traffic control and pilots;
monitor, onboard the aircraft, the clearances to track when the clearances are executed;
extract the corresponding text for the at least one of the action, the object type, or the object identification from the text regarding the clearances that are executed; and
at least a second processor integrated into a mobile device onboard the aircraft, the at least the second processor configured to:
tag the corresponding text with the corresponding separate audio file for the at least one of the action, the object type, or the object identification.

3. The system of claim 1, wherein the mobile device is selected from at least one of a tablet, a laptop, and a smartphone.

4. The system of claim 1, wherein the at least one processor is configured to implement:
a voice transcription system configured to:
record the spoken audio communication between the air traffic control and the pilot onboard the aircraft; and
tag the source of the spoken audio communication as being the at least one of the air traffic control or the pilot onboard the aircraft;
an audio separation system configured to:
split the spoken audio communication into the corresponding separate audio files for at least the source of the instruction and the at least one of the action, the object type, or the object identification; and
remove any corresponding separate audio files for any non-standard words from the spoken audio communication which are not included in the list of the standard vocabulary for the communication between the air traffic control and the pilots;
a clearance monitoring system configured to:
monitor the clearances to track when the clearances are executed;
a text extraction system configured to:
extract the corresponding text for the at least one of the action, the object type, or the object identification from the text regarding the clearances that are executed; and
a voice and text tagging system configured to:
tag the corresponding text with the corresponding separate audio file for the at least one of the action, the object type, or the object identification.

5. The system of claim 1, wherein the at least one processor is further configured to:
output the corresponding text with the corresponding separate audio file for the at least one of the action, the object type, or the object identification.

6. The system of claim 5, wherein the at least one processor is further configured to:
retraining a machine learning model based on the corresponding text and the corresponding separate audio file.

7. The system of claim 5, wherein the at least one processor is further configured to:
combine the corresponding text and the corresponding separate audio file with other corresponding text and corresponding audio files to generate a corpus of data; and
retrain a machine learning model based on the corpus of data.

8. A method comprising:
recording, onboard an aircraft, spoken audio communication between air traffic control and a pilot onboard the aircraft;
tagging a source of the spoken audio communication as being at least one of the air traffic control or the pilot onboard the aircraft;
splitting the spoken audio communication into corresponding separate audio files for at least the source of an instruction and at least one of an action, an object type, or an object identification;
removing any corresponding separate audio files for any non-standard words from the spoken audio communication which are not included in a list of standard vocabulary for communication between the air traffic control and pilots;
monitoring, onboard the aircraft, clearances to track when the clearances are executed;
extracting corresponding text for the at least one of the action, the object type, or the object identification from text regarding the clearances that are executed; and
tagging the corresponding text with a corresponding separate audio file for the at least one of the action, the object type, or the object identification.

9. The method of claim 8, further comprising:
recording, using avionics onboard the aircraft, the spoken audio communication between the air traffic control and the pilot onboard the aircraft;
tagging, using the avionics onboard the aircraft, the source of the spoken audio communication as being the at least one of the air traffic control or the pilot onboard the aircraft;
splitting, using the avionics onboard the aircraft, the spoken audio communication into the corresponding separate audio files for the at least the source of the instruction and the at least one of the action, the object type, or the object identification;
removing, using the avionics onboard the aircraft, any corresponding separate audio files for any non-standard words from the spoken audio communication which are not included in the list of the standard vocabulary for the communication between the air traffic control and the pilots;
monitoring, using the avionics onboard the aircraft, the clearances to track when the clearances are executed;
extracting, using the avionics onboard the aircraft, the corresponding text for the at least one of the action, the object type, or the object identification from the text regarding the clearances that are executed; and
tagging, using a mobile device onboard the aircraft, the corresponding text with the corresponding separate audio file for the at least one of the action, the object type, or the object identification.

10. The method of claim 9, wherein the mobile device is selected from at least one of a tablet, a laptop, and a smartphone.

11. The method of claim 8, further comprising:
recording, using a voice transcription system, the spoken audio communication between the air traffic control and the pilot onboard the aircraft;
tagging, using a voice and text tagging system, the source of the spoken audio communication as being the at least one of the air traffic control or the pilot onboard the aircraft;
splitting, using an audio separation system, the spoken audio communication into the corresponding separate audio files for the at least the source of the instruction and the at least one of the action, the object type, or the object identification;
removing, using the audio separation system, any corresponding separate audio files for any non-standard words from the spoken audio communication which are not included in the list of the standard vocabulary for the communication between the air traffic control and the pilots;
monitoring, using a clearance monitoring system, the clearances to track when the clearances are executed;
extracting, using a text extraction system, the corresponding text for the at least one of the action, the object type, or the object identification from the text regarding the clearances that are executed; and
tagging, using the voice and text tagging system, the corresponding text with the corresponding separate audio file for the at least one of the action, the object type, or the object identification.

12. The method of claim 8, further comprising:
outputting the corresponding text with the corresponding separate audio file for the at least one of the action, the object type, or the object identification.

13. The method of claim 12, further comprising:
retraining a machine learning model based on the corresponding text and the corresponding separate audio file.

14. The method of claim 12, further comprising:
combining the corresponding text and the corresponding separate audio file with other corresponding text and corresponding audio files to generate a corpus of data; and
retraining a machine learning model based on the corpus of data.

15. A non-transitory computer-readable medium comprises a set of instructions that, when executed by at least one processor, cause the at least one processor to:
record, onboard an aircraft, spoken audio communication between air traffic control and a pilot onboard the aircraft;
tag a source of the spoken audio communication as being at least one of the air traffic control or the pilot onboard the aircraft;
split the spoken audio communication into corresponding separate audio files for at least the source of an instruction and at least one of an action, an object type, or an object identification;
remove any corresponding separate audio files for any non-standard words from the spoken audio communication which are not included in a list of standard vocabulary for communication between the air traffic control and pilots;
monitor, onboard the aircraft, clearances to track when the clearances are executed;
extract corresponding text for the at least one of the action, the object type, or the object identification from text regarding the clearances that are executed; and
tag the corresponding text with a corresponding separate audio file for the at least one of the action, the object type, or the object identification.

16. The non-transitory computer-readable medium of claim 15, further comprising:
wherein the set of instructions comprises a first subset of instructions and a second subset of instructions;
wherein the at least one processor comprises:
at least a first processor integrated into avionics systems integrated into the aircraft; and
at least a second processor integrated into a mobile device onboard the aircraft;
wherein the first subset of instructions, when executed by the at least the first processor integrated into the avionics systems integrated into the aircraft, cause the at least the first processor to:
record, onboard the aircraft, the spoken audio communication between air traffic control and the pilot onboard the aircraft;
tag the source of the spoken audio communication as being the at least one of the air traffic control or the pilot onboard the aircraft; and
split the spoken audio communication into the corresponding separate audio files for at least the source of the instruction and the at least one of the action, the object type, or the object identification;
remove any corresponding separate audio files for any non-standard words from the spoken audio communication which are not included in the list of the standard vocabulary for the communication between the air traffic control and pilots;
monitor, onboard the aircraft, the clearances to track when the clearances are executed;
extract the corresponding text for the at least one of the action, the object type, or the object identification from the text regarding the clearances that are executed; and
wherein the first subset of instructions, when executed by the at least the second processor integrated into the mobile device onboard the aircraft, cause the at least the second processor to:
tag the corresponding text with the corresponding separate audio file for the at least one of the action, the object type, or the object identification.

17. The non-transitory computer-readable medium of claim 16, wherein the mobile device is selected from at least one of a tablet, a laptop, and a smartphone.

18. The non-transitory computer-readable medium of claim 16, wherein the set of instructions further cause the at least one processor to:
output the corresponding text with the corresponding separate audio file for the at least one of the action, the object type, or the object identification.

19. The non-transitory computer-readable medium of claim 18, wherein the set of instructions further cause the at least one processor to:
retrain a machine learning model based on the corresponding text and the corresponding separate audio file.

20. The non-transitory computer-readable medium of claim 18, wherein the set of instructions further cause the at least one processor to:
combine the corresponding text and the corresponding separate audio file with other corresponding text and corresponding audio files to generate a corpus of data; and
retrain a machine learning model based on the corpus of data.
